(19) United States
(12) Patent Application Publication
(10) Pub. No.: US 2009/0057121 A1
(43) Pub. Date: Mar. 5, 2009

(54) Key Base, Key Sheet and Method of Forming Key Base

(75) Inventors: Minoru Yoshida, Nigata (JP); Yoshitaka Kamata, Nigata (JP)

Correspondence Address: HEDMAN & COSTIGAN P.C., 1185 AVENUE OF THE AMERICAS, NEW YORK, NY, 10036, US

(73) Assignee: SUNARROW LTD., Chuo-Ku, Tokyo (JP)

(21) Appl. No.: 12/223,702

(22) PCT Filed: Aug. 23, 2006
(86) PCT No.: PCT/JP2006/317026

§ 371 Date: Aug. 6, 2008

(30) Foreign Application Priority Data
Feb. 7, 2006 (JP) 2006-030343

(51) Int. Cl. H01H 13/702; H01H 11/00; H01H 13/14

(52) U.S. Cl. 200/5 A; 29/622

(57) ABSTRACT

The present invention has an object thereof is to provide a key base which can be thinned, a key sheet which can be thinned and a method of forming a key base which can be thinned.

According to a first aspect, there is provided a key base comprising: a flexible film sheet; and a plurality of pressers made of a non-thermo-curing type material and formed integrally with the film sheet on the backside of the film sheet.

### BACKGROUND OF THE INVENTION

1. Field of the Invention

The present invention relates to a key base and a key sheet for use in an electronics device such as a cellular phone (including a so-called PHS), a portable information terminal (personal digital assistance (PDA) or the like), a portable audio, a remote controller for household electric appliances or a keyboard. It also relates to a method of forming the key base.

2. Description of the Related Art

A key sheet for use in a cellular phone, a portable information terminal or the like is mainly constituted by forming a key top made of a hard resin on a keypad (key base) obtained by forming a rubber-like elastic material such as a silicone rubber into a sheet shape (see Patent Document 1). If necessary, the keypad is formed integrally with a presser which presses and deforms a metal dome or the like and which is made of the same material as that of the keypad.

In recent years, from a demand for miniaturizing and thinning of a device, there is a demand for further thinning of the key sheet. To thin the key sheet, the key base constituting this key sheet needs to be thinned.

However, there has been a limit to the thinning of the keypad formed of the rubber-like elastic material into the sheet shape, especially a keypad made of a silicone rubber owing to a problem with strength or the like. To solve the problem, the key sheet is developed in which a film sheet made of urethane or polyethylene terephthalate (hereinafter referred to as PET) is used in the key base.

By the way, the backside of the film sheet for use in the key base is basically substantially flat. Therefore, when the presser is required for the key base, the presser needs to be formed on the backside of the film sheet. To form the presser on the backside of the film sheet, there is considered a method in which a sheet-like member including the presser and made of a silicone rubber is formed integrally with the film sheet.

[Patent Document 1] Japanese Patent Application Laid-Open No. 2005-5234 (see claim 1, drawings, etc.)

However, the sheet-like member including the presser and made of the silicone rubber is formed by compression molding. In the compression molding, owing to fluidity of the silicone rubber or the like, there is especially a limit to the thinning of a portion other than the presser. Therefore, there is a limit to the thinning of the key base in which the sheet-like member made of the silicone rubber is formed integrally with the film sheet.

### SUMMARY OF INVENTION

The present invention has been developed in view of the above problem, and an object thereof is to provide a key base which can be thinned, a key sheet which can be thinned and a method of forming a key base which can be thinned.

To solve the above problem, according to a first aspect, there is provided a key base comprising: a flexible film sheet; and a plurality of pressers made of a non-thermo-curing type material and formed integrally with the film sheet on the backside of the film sheet.

When the pressers are formed using the non-thermo-curing type material integrally with the film sheet, the pressers can be formed without using compression molding. Therefore, the above-described limit to the thinning is eliminated. Accordingly, the key base can be thinned.

In the present invention, a heating type adhesive layer is beforehand formed on the surface of the film sheet.

To cure the non-thermo-curing type material, the material is not heated. Therefore, without influencing the heating type adhesive layer on the surface of the film sheet, this non-thermo-curing type material can be cured, and the pressers can be formed integrally with this film sheet on the backside of the film sheet.

According to another aspect, there is provided a key sheet comprising: a flexible film sheet; a plurality of key tops arranged on the surface of the film sheet; and a plurality of pressers made of a non-thermo-curing type material and formed integrally with the film sheet in positions corresponding to those of the key tops on the backside of the film sheet.

When the pressers made of the non-thermo-curing type material are formed integrally with the film sheet, the pressers can be formed without using compression molding. Therefore, the above-described limit to the thinning is eliminated. Accordingly, the key base can be thinned, and the key sheet can also be thinned. It is to be noted that in a case where plate-like key tops are used as described later in an embodiment, the key tops refer to portions having a predetermined size in positions corresponding to those of portions of the plate-like key tops, such as a multidirectional (cursor) key, ten keys and a function key, that is, positions corresponding to those of switch portions such as one or a plurality of metal domes.

In the key sheet of the present invention, a heating type adhesive layer is formed beforehand on the surface of the film sheet, and the key tops are firmly fixed by this adhesive layer.

To cure the non-thermo-curing type material, the material is not heated. Therefore, without influencing the heating type adhesive layer on the surface of the film sheet, this non-thermo-curing type material can be cured, and the pressers can be formed integrally with this film sheet on the backside of the film sheet.

In the key base or the key sheet of the present invention, the heating type adhesive layer is a hot-melt layer, and formed all over the film sheet.

For example, when an adhesive is applied to the film sheet or the key top backside to bond the key tops, only portions of the key tops coated with the adhesive are bonded to the film sheet. Therefore, there are non-bonded portions on the undersides of the key tops. Therefore, there is a disadvantage that the key top is raised from the non-bonded underside of the key top, and the raised key top peels from the film sheet. In a case where the hot-melt layer is formed all over the film sheet, when the key tops are firmly fixed, the key tops can be entirely bonded the film sheet. This is, there are not any non-bonded portion of the underside of the key top. For this reason, the disadvantage that above the key top peels from the film sheet can be eliminated.

According to still another aspect of the present invention, there is provided a method of forming a key base, comprising: a first step of supplying a non-thermo-curing type material to a mold having a concave portion in a desired position; a second step of supplying a flexible film sheet to the mold to which the non-thermo-curing type material has been supplied so that the backside of the film sheet faces downwards; and a third step of curing the non-thermo-curing type material to form pressers integrally with the film sheet on the backside of the film sheet.

Since the pressers are formed integrally with the film sheet by use of the non-thermo-curing type material, the pressers can be formed without performing the compression molding. Therefore, the above-described limit to the thinning is eliminated. Accordingly, the key base can be thinned.

The method of forming the key base according to the present invention further comprises: a step of smoothing the non-thermo-curing type material supplied to the mold with a squeegee, a doctor blade, a roller or the like after the first step.

When the non-thermo-curing type material supplied to the mold is smoothed with the squeegee, the doctor blade, the roller or the like, the non-thermo-curing type material in the mold can be uniform. In this case, an extra non-thermo-curing type material supplied to the mold can be removed, and the key base can further be thinned.

In the method of forming the key base of the present invention, the third step is a step of pressurizing the non-thermo-curing type material and the film sheet from a thickness direction before or while curing the non-thermo-curing type material, and curing the non-thermo-curing type material to form the pressers integrally with the film sheet on the backside of the film sheet.

When the non-thermo-curing type material and the film sheet are pressed, the excess non-thermo-curing type material supplied can overflow, and the key base can further be thinned.

In the method of forming the key base of the present invention, a heating type adhesive layer is formed on the surface of the film sheet.

To cure the non-thermo-curing type material, the material is not heated. Therefore, without influencing the heating type adhesive layer on the surface of the film sheet, this non-thermo-curing type material can be cured, and the pressers can be formed integrally with this film sheet on the backside of the film sheet.

In the method of forming the key base of the present invention, the heating type adhesive layer is a hot-melt layer, and formed all over the film sheet.

In a case where the hot-melt layer is formed all over the film sheet, when the key tops are firmly fixed, the key tops can be entirely bonded the film sheet. Therefore, it is possible to form the key base having the same effect as the above-described effect.

According to the key base, the key sheet and the method of forming the key base of the present invention, the key base and the key sheet can be thinned.

### BRIEF DESCRIPTION OF THE DRAWINGS

FIG. 1 is an exploded perspective view illustrating a key sheet in one example of the present invention, and a substrate on which this key sheet is to be disposed;

FIG. 2 is a perspective view illustrating the surface of the key sheet in one example of the present invention;

FIG. 3 is a perspective view illustrating the backside of the key sheet in one example of the present invention;

FIG. 4 is an enlarged sectional view illustrating a ten-key portion disposed on a substrate of the key sheet in one example of the present invention;

FIG. 5 illustrates a cellular phone in which the key sheet of one example of the present invention is incorporated;

FIG. 6 is an exploded perspective view illustrating a key sheet of one example of the present invention and a substrate on which this key sheet is to be disposed; and

FIG. 7 illustrates a procedure of a method of forming the key base and an outline of each procedure.

### DESCRIPTION OF THE PREFERRED EMBODIMENT

There will be described one example of a key sheet for use in a cellular phone in an embodiment of the present invention with reference to the drawings. It is to be noted that similar parts, corresponding parts and generic parts will be denoted with the same reference numerals. In a case where there are a plurality of similar parts, corresponding parts and generic parts, an only part of them are denoted with the reference numerals.

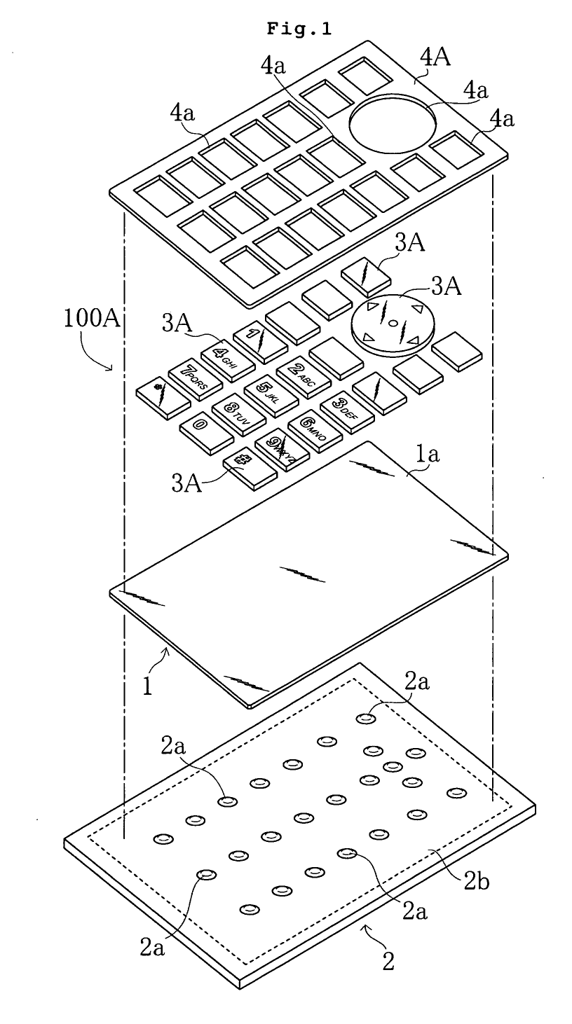

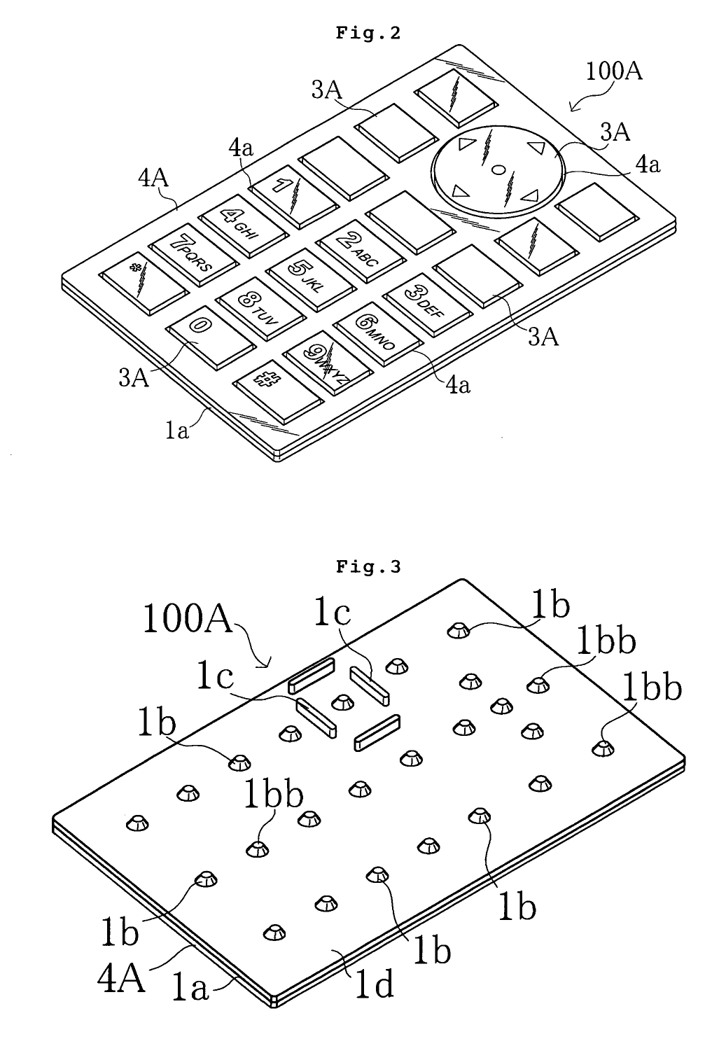

FIG. 1 is an exploded perspective view illustrating a key sheet 100A in one example of the present invention, and a substrate 2 on which this key sheet 100A is to be disposed. FIG. 2 is a perspective view illustrating the surface of the key sheet 100A in one example of the present invention. FIG. 3 is a perspective view illustrating the backside of the key sheet 100A in one example of the present invention.

The key sheet 100A includes a key base 1, a plurality of key tops 3A such as a multidirectional (cursor) key, ten keys and a function key, and a cover member 4A. This key sheet 100A is disposed on the substrate 2.

The key base 1 includes a flexible film sheet 1a and a plurality of pressers 1b. The plurality of pressers 1b are disposed in desired positions, respectively.

The pressers 1b are formed integrally with the film sheet 1a by use of a non-thermo-curing type material on the backside of the film sheet 1a.

The flexible film sheet 1a is realized by, for example, a thermoplastic urethane film having a thickness of about 0.05 mm. The flexible film sheet 1a may have a multilayered structure in which a plurality of films are laminated.

The non-thermo-curing type material is a material which is liquid at normal temperature and which can be cured by performing a predetermined treatment without heating the material, and the material is realized by, for example, an ultraviolet (UV) curing resin, a visible light curing resin, an electromagnetic wave curing resin or the like.

The forming of the pressers 1b will be described later. When the pressers 1b are formed, a thin portion 1d is formed integrally with the pressers 1b all over a region other than the pressers 1b on the backside of the film sheet 1a. It is to be noted that in FIG. 3, the thin portion 1d is formed all over the region other than the plurality of pressers 1b on the backside of the film sheet 1a, but the thin portion 1d may be formed in a part of the region.

When the key sheet 100A is an illumination type key sheet (which refers to a key sheet having the key tops 3A illuminated with a predetermined light source, and this applies to the following), the thin portion 1d may be formed all over the region other than the plurality of pressers 1b on the backside of the film sheet 1a instead of forming the thin portion in a part of the region, so that the illumination of the key tops 3A are not influenced.

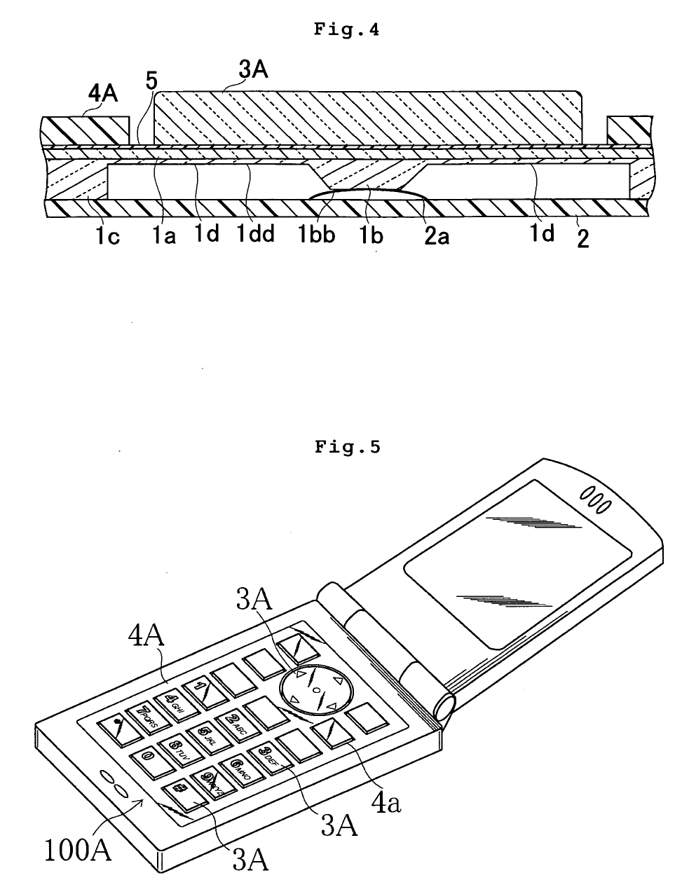

Each of the pressers 1b needs to have a minimum height to press metal dome 2a (distance from a top 1dd of the thin portion 1d to a vertex 1bb of the presser 1b: approx. 0.2 mm, refer to FIG. 4). Therefore, a degree to which this thin portion 1d can be thinned is a key to thin the key sheet 100A.

It is to be noted that the plurality of pressers 1b may be formed so as to prevent the thin portion 1d from being formed. In this case, the key base 1 can be thinnest.

Spacers 1c are formed on the backside of the film sheet 1a. The spacers 1c are formed so that the adjacent key tops 3A are not influenced in a case where one of the key tops 3A is depressed.

It is to be noted that in FIG. 3, for the sake of the description, the spacers 1c are formed only on a part, but the spacers 1c may basically appropriately be arranged everywhere they are needed (e.g., between two key tops 3A). In a case where there are spacers on the side of the substrate 2, the spacers 1c may not be disposed in some case.

In a case where the thin portion 1d is formed as described above, the spacers 1c are formed of the same material as that of the thin portion 1d integrally with the thin portion 1d. That is, the pressers 1b, the spacers 1c and the thin portion 1d are formed of the same material integrally with the film sheet 1a.

The spacers 1c do not have to be formed of the same material as that of the pressers 1b, and may separately be formed of a material different from that of the pressers 1b and the thin portion 1d.

The key tops 3A are arranged by bonding the key tops to desired positions on the surface of the key base 1, that is, the surface of the flexible film sheet 1a, respectively.

The cover member 4A is disposed by bonding the cover member to the surface of the film sheet 1a. This cover member 4A has through holes 4a in positions corresponding to the key tops 3A, respectively. One key top 3A is positioned in one through hole 4a. The cover member 4A protects at least a part of a region where the key tops 3A are not present on the key base 1. The cover member 4A imparts rigidity to the whole key sheet 100A.

It is to be noted that the cover member 4A may be a plurality of cover members. Instead of forming one through hole 4a for one key top 3A as illustrated in FIGS. 1 and 2, one through hole may be formed for a plurality of key tops 3A.

The film sheet 1a is bonded to the key tops 3A and the cover member 4A by a heating type adhesive layer formed on the whole surface (or a part of the surface) of the film sheet 1a. The heating type adhesive layer is heated to thereby bond the key tops 3A and the cover member 4A to the film sheet 1a.

As the heating type adhesive layer, for example, there is a hot-melt adhesive layer (referred to simply as the “hot-melt layer” in the present invention). The hot-melt layer is disposed on the whole surface of the film sheet 1a.

The key tops 3A and the cover member 4A are arranged in desired positions on the heating type adhesive layer formed on the whole surface of the film sheet 1a, and heated at a predetermined temperature. Thereafter, when the temperature of the heating type adhesive layer drops, the key tops 3A and the cover member 4A are entirely bonded to the surface of the film sheet 1a.

When the key tops 3A and the cover member 4A are entirely bonded to the surface of the film sheet 1a, there is not any non-bonded portion on undersides of the key tops 3A and the cover member 4A. Therefore, it is possible to eliminate a disadvantage that the key tops 3A and the cover member 4A peel from the film sheet 1a.

The key tops 3A and the cover member 4A are made of the material such as any synthetic resin including a hard resin like a polycarbonate resin, a polyurethane resin or a silicone resin. Also, they are made of any glass, any type of metal thin plate, or the like. On the surfaces or the backsides of the key tops 3A, numerals, characters, symbols, patterns or the like are represented by an appropriate method such as printing or painting (in a metal thin plate, a through hole having a shape of the numeral, the character or the like is disposed by etching or the like).

It is to be noted that in a case where the key sheet 100A is an illumination type key sheet, it is assumed that the film sheet 1a, the pressers 1b, the key tops 3A and the heating type adhesive layer appropriately have light-transmitting. The cover member 4A may be light-transmitting or light-shielding from a viewpoint of design.

Moreover, a light-shielding layer (including a layer which interrupts light so that the light from a predetermined light source does not leak from inadequate parts and which is formed by direct printing on the key base or the like or which is formed separately from the key base) may appropriately be disposed in a necessary place.

Moreover, when the key tops 3A (or the cover member 4A) are entirely bonded to the surface of the film sheet 1a, uniform light-transmittance is obtained as compared with a case where, for example, the adhesive is applied to the film sheet 1a or the key tops 3A (or the cover member 4A) to bond the key tops 3A or the like. In a case where the adhesive is applied to bond the key tops or the like, the film sheet 1a is bonded to the key tops 3A in only portions where the adhesive is present. Therefore, unevenness is sometimes generated in the light transmittance in the portion where the adhesive is present and a portion where any adhesive is not present on the undersides of the key tops 3A.

The substrate 2 has such as an electronic element, and a circuit, a contact to be short-circuited by metal domes 2a or others (not illustrated) mounted on the substrate.

The metal domes 2a are fixed to the substrate 2 by a film 2b (illustrated by a dotted line in FIG. 1). The film 2b is made of PET, PC or the like. It is to be noted that the metal dome 2a and contact may appropriately be changed to another switch portion which generates a sense of click. For example, the another switch portion is poly dome and contact or micro switch. To pursue thinning, however, it is preferable to employ the metal domes made of a stainless steel (SUS or the like). It is to be noted that in this embodiment, it is assumed that a thickness of the metal dome 2a and the film 2b (height from the surface of the substrate 2 to the most protruding portion of this dome) is 0.25 mm or less.

Each key top 3A, each presser 1b and each metal dome 2a are positioned so as to correspond with one another (see FIG. 4 also). When the key top 3A is depressed, the presser 1b moves downwards, and this presser 1b presses and deforms the metal dome 2a. Moreover, the pressed and deformed metal dome 2a short-circuits a contact right under the metal dome 2a. This short-circuiting makes an electric switching operation possible. According to the metal dome 2a, it is possible to obtain the sense of click at a time when the key top 3A is depressed.

FIG. 4 is an enlarged sectional view illustrating a ten-key portion in a case where the key sheet 100A is disposed on the substrate 2.

The pressers 1b, the spacers 1c and the thin portion 1d are made of the same material, and formed integrally with the film sheet 1a.

The key sheet 100A abuts on the substrate 2 via the spacers 1c. Even when one key top 3A is depressed, the adjacent key top 3A is not influenced owing to the spacers 1c. Furthermore, the vertex 1bb of the presser 1b abuts on the metal dome 2a (accurately the film 2b).

The key tops 3A and the cover member 4A are bonded to the surface of the film sheet 1a via a heating type adhesive layer 5.

It is assumed that the heating type adhesive layer 5 is formed on the whole surface of the film sheet 1a. The key tops 3A and the cover member 4A are entirely bonded to the surface of the film sheet 1a.

Moreover, there is commercially available a film sheet 1a on the whole surface of which a heating type adhesive layer 5 is disposed beforehand. For example, the film sheet 1a is an urethane film on the whole surface of which the hot-melt layer is disposed. In a case where there is used film sheet 1a on the whole surface of which this heating type adhesive layer is disposed, the heating type adhesive layer 5 does not have to be newly disposed, and a step of forming the adhesive layer (applying of the adhesive or the like) can be omitted in producing the key sheet.

It is to be noted that in the key base in which the film sheet made of a hard resin such as PET is used, since this film sheet is hard, a slit has to be disposed around a position of the key base where the key top is disposed. Therefore, in a case where there is employed the key base in which the film sheet made of a hard resin such as PET is used, there is a disadvantage that a step of disposing the slit has to be added.

As compared with this case, when the flexible film sheet 1a is used in the key base 1, the film sheet 1a can be bent in a predetermined place, the key tops 3A can smoothly be depressed. Therefore, it is not necessary to add the step of forming the slit in a case where there is employed the key base using the film sheet made of a hard resin such as PET.

Moreover, in a case where the thin portion 1d is formed, the non-thermo-curing type material does not have to be hard, and it is preferable to use a soft material which has flexibility to a certain degree. In a case where the material is cured, when the material is not flexible, the thin portion 1d cracks if the film sheet 1a is bent. This influences the illumination of the key tops 3A especially in a case where the key sheet 100A is the illumination type key sheet.

FIG. 5 illustrates a cellular phone in which the key sheet 100A is incorporated. It is to be noted that in a case where the key sheet of the present invention is incorporated in a phone having a partition bar, the cover member 4A is not required. In this case, a flange which abuts on this partition bar is sometimes disposed in a peripheral edge of a lower portion of each key top 3A.

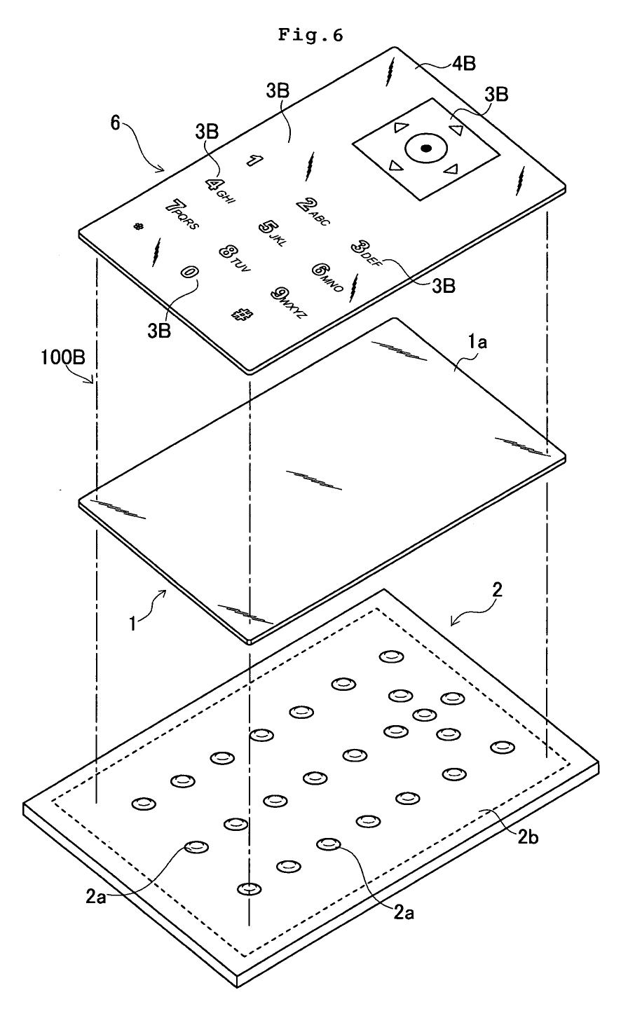

FIG. 6 is an exploded perspective view illustrating a key sheet 100B of another example of the present invention and a substrate 2 on which this key sheet 100B is to be disposed. The key sheet 100B is largely different from the key sheet 100A in that one plate-like key top 6 is disposed on a key base 1 to thereby form the key sheet 100B.

The plate-like key top 6 is made of a light transmitting hard resin such as PET, or any type of metal thin plate, and a plurality of key tops 3B and a cover member 4B are integrally formed. That is, the plate-like key top 6 includes the key tops 3B and the cover member 4B as constituting elements. On the surface or the backside of the plate-like key top 6, a character or the like is represented by a through-hole of character or the like. It is to be noted that in FIG. 6, the key tops 3B refer to portions having predetermined sizes in positions corresponding to portions such as a multidirectional (cursor) key, ten keys and function keys (symbols indicating functions are not illustrated in FIG. 6) of this plate-like key top 6, that is, switch portions such as one or a plurality (especially a plurality of multidirectional (cursor) keys) of metal domes 2a.

Since the other description conforms to the above description, the description is omitted. It is to be noted that when the plate-like key top 6 is entirely bonded to the key base 1, for a reason similar to the above reason, it is possible to eliminate a disadvantage that the plate-like key top 6 peels from the film sheet 1a. When the plate-like key top 6 is entirely bonded to the key base 1, for a reason similar to the above reason, uniform light transmittance can be obtained.

Next, one example of a method of forming the key base 1 (forming the pressers) will be described.

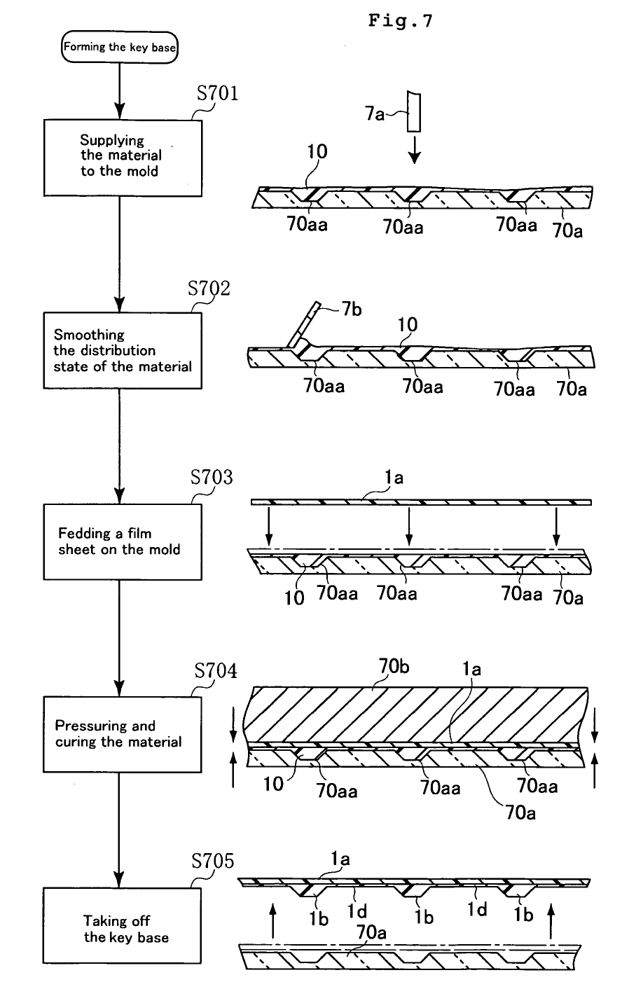

FIG. 7 illustrates a procedure of the method of forming the key base 1 and an outline of each procedure. It is to be noted that in the present example, the film sheet 1a is an urethane film 1a, and a non-thermo-curing type material is a UV curing resin 10, but the material can appropriately be changed.

The UV curing resin 10 is supplied to a mold 70a having concave portions 70aa in desired positions (S701).

To supply the UV curing resin 10, the UV curing resin 10 is, for example, discharged and supplied from a discharge nozzle 7a.

The mold 70a has a plurality of concave portions 70aa having predetermined shapes for arranging pressers 1b in desired positions. Assuming that spacers 1c are integrally formed, the mold 70a has a plurality of concave portions (not illustrated) having predetermined shapes for arranging the spacers 1c in desired positions.

The UV curing resin 10 may be individually dropped into the concave portions 70aa or the concave portions (not illustrated) by use of a dispenser or the like so as to fill in the concave portions 70aa or the concave portions (not illustrated). In this case, the thin portion 1d is not formed.

The UV curing resin 10 supplied to the mold 70a is smoothed with a squeegee 7b (S702). As illustrated, the squeegee 7b is allowed to run on the UV curing resin 10. It is to be noted that at this time, if all of the UV curing resin 10 other than the UV curing resin 10 reserved in the concave portions 70aa or the concave portions (not illustrated) is removed with the squeegee 7b, the thin portion 1d is not formed. Instead of removing all of the resin, at this time, the excess UV curing resin 10 may be removed, and the thin portion 1d may be thinned. It is to be noted that the squeegee 7b may appropriately be changed to a doctor blade, a roller or the like for smoothing the UV curing resin 10.

A flexible urethane film 1a is supplied to the mold 70a to which the UV curing resin 10 has been supplied so that the backside of the film faces downwards (S703).

The UV curing resin 10 and the urethane film 1a are pressurized from a thickness direction before or while curing the UV curing resin 10, and the UV curing resin 10 is cured to form the pressers integrally with the urethane film 1a on the backside of the urethane film 1a (S704).

The UV curing resin 10 and the urethane film 1a are pressurized from the thickness direction by the mold 70a and a mold 70b. The pressurizing may be performed by moving the mold 70a and the mold 70b, or may be performed by fixing either of them. This pressurizing can allow the excess UV curing resin 10 to overflow between the mold 70a and the mold 70b, and the thin portion 1d can be thinned. If a pressure of the pressurizing is high, the thin portion 1d can further be thinned.

Furthermore, after the pressurizing, the UV curing resin 10 is cured. For example, the top of the mold 70a and/or the underside of the mold 70b are made of glass or the like, a UV lamp is disposed under or above this glass, and an ultraviolet ray is applied to the UV curing resin 10 to cure this UV curing resin 10. During the pressurizing, the ultraviolet ray may be applied to the UV curing resin 10 to cure this UV curing resin 10. It is to be noted that in a case where the non-thermo-curing type material is cured during the pressurizing, depending upon the type of the non-thermo-curing type material (including the UV curing resin), the curing (curing reaction) of the material might be hampered by the pressurizing. Therefore, depending upon the material, there is a case where the material is cured after the pressurizing.

When the UV curing resin 10 cures, the UV curing resin 10 in the concave portions 70aa forms the pressers 1b, and the UV curing resin 10 in the concave portions (not illustrated) forms the spacers 1c. The other UV curing resin 10 forms the thin portion 1d. When the UV curing resin 10 cures, the UV curing resin 10 is integrated with the urethane film 1a. That is, when the UV curing resin 10 cures, the pressers 1b, the spacers 1c and the thin portion 1d are formed integrally with the urethane film 1a.

After the UV curing resin 10 cures, the key base 1 is completed (S705).

In a case where the UV curing resin 10 is used in the pressers 1b, since heating is not necessary in the present forming process, the urethane film 1a is not adversely affected. In a case where the heating type adhesive layer, especially the hot-melt layer is formed beforehand on the surface of the urethane film 1a, the heating is not necessary in the present forming process, and therefore the hot-melt layer can be prevented from changing in its properties by the heating.

In the key sheets 100A and 100B in which the key base 1 formed as described above is used, as to a total thickness of each sheet, thicknesses of the thickest portions (from the surface of the substrate 2 to the key top 3A) are about 0.69 mm and about 0.49 mm, respectively.

What is claimed is:

1. A key base comprising:
a flexible film sheet; and
a plurality of pressers made of a non-thermo-curing type material and formed integrally with the film sheet on the backside of the film sheet.

2. The key base according to claim 1, wherein a heating type adhesive layer is beforehand formed on the surface of the film sheet.

3. A key sheet comprising:
a flexible film sheet;
a plurality of key tops arranged on the surface of the film sheet; and
a plurality of pressers made of a non-thermo-curing type material and formed integrally with the film sheet in positions corresponding to those of the key tops on the backside of the film sheet.

4. The key sheet according to claim 3, wherein a heating type adhesive layer is formed beforehand on the surface of the film sheet, and the key tops are firmly fixed by this adhesive layer.

5. The key base according to claim 2 or the key sheet according to claim 4, wherein the heating type adhesive layer is a hot-melt layer, and formed all over the film sheet.

6. A method of forming a key base, comprising:
a first step of supplying a non-thermo-curing type material to a mold having a concave portion in a desired position;
a second step of supplying a flexible film sheet to the mold to which the non-thermo-curing type material has been supplied so that the backside of the film sheet faces downwards; and
a third step of curing the non-thermo-curing type material to form pressers integrally with the film sheet on the backside of the film sheet.

7. The method of forming the key base according to claim 6, further comprising:
a step of smoothing the non-thermo-curing type material supplied to the mold with a squeegee, a doctor blade, a roller or the like after the first step.

8. The method of forming the key base according to claim 6 or 7, wherein the third step is a step of pressurizing the non-thermo-curing type material and the film sheet from a thickness direction before or while curing the non-thermo-curing type material, and curing the non-thermo-curing type material to form the pressers integrally with the film sheet on the backside of the film sheet.

9. The method of forming the key base according to claim 6, wherein a heating type adhesive layer is formed on the surface of the film sheet.

10. The method of forming the key base according to claim 9, wherein the heating type adhesive layer is a hot-melt layer, and formed all over the film sheet.
